(19) United States
(12) Patent Application Publication
(10) Pub. No.: US 2003/0009410 A1
(43) Pub. Date: Jan. 9, 2003

(54) Collaboration bill of material

(76) Inventors: Padman Ramankutty, Union City, CA (US); Nageshwara R. Vempaty, Palo Alto, CA (US); Vivek Agarwal, Santa Clara, CA (US)

Correspondence Address: GARY CARY WARE & FREIDENRICH LLP, 1755 EMBARCADERO ROAD, PALO ALTO, CA, 94303-3340, US

(21) Appl. No.: 09/892,346

(22) Filed: Jun. 26, 2001

(51) Int. Cl. G06F 17/60

(52) U.S. Cl. 705/37

(57) ABSTRACT

The present invention provides a software engine, a CBOM (collaboration bill of materials), to automate the collaboration process on a BOM that is distributed over the supply chain network and the demand chain network. In one embodiment of the invention, the CBOM comprises a rules engine, an optimization engine, an applications server and a database server. The rules engine implements rule-based decision making functions. The optimization engine of the CBOM allows the distributed system to resolve routine problems that may reoccur on a regular basis and provide a preferred, well-tested and unambiguous resolution to the routine problems. In one embodiment of the invention, the CBOM monitors for an arrival of an input or an event entered by a business party in the distributed production system. When an input is received by the CBOM, the CBOM performs an intelligent decision making by determining whether the input represents an out-of-tolerance case. If the input represents an out-of-tolerance case, the CBOM notifies a user or other business parties across the distributed system of difficulties and delays in production. If the input does not represent an out-of-tolerance case, the optimization engine of the CBOM crafts a corrective action in response to the input.

### FIELD OF THE INVENTION

This invention relates generally to a bill of material management technique. More specifically, the invention relates to system and method for managing commercial and manufacturing entities in a distributed system.

### BACKGROUND OF THE INVENTION

A BOM (bill of material) comprises information regarding components, parts, and assemblies and their various relationships for a product. A BOM is typically stored in a database as a data structure. When companies assemble products from components, they can specify the parts and sub-parts necessary for the manufacturing of the products based on a BOM, which may be maintained in a database. Work orders can be created from a bill of material and availability of the necessary parts and sub-parts to complete a production order can be easily determined from a BOM.

Typically, a company (product brand-owner) creates and manufactures products using a design specification BOM and a production BOM. A company's engineering team completes a product design and releases the production BOM to a manufacturing team (in-house or at an outsource). The production BOM usually takes the form of a hierarchical structure that lists all the components, subassemblies, and/or parts that make up the product as it is designed. If the components themselves have sub-assemblies or parts, these are also listed in the BOM.

The product brand-owner typically assembles and manages the BOM using a product data management system (PDM) or an enterprise resource planning system (ERP). Elements of the BOM may also be managed in supply chain planning systems (SCMs) and warehouse management systems (WMs). The suppliers to the brand owner may also need to manage components of the BOM because the components are sub-assemblies themselves. Thus the suppliers may need their own BOMs for the sub-assemblies. Further, there may be more BOMs in the supply chain because the sub-assemblies, in turn, may have their own sub-assemblies and their own BOMs.

Thus, if the brand-owner maintains diverse systems owned and managed by various companies that populate the brand owner's multi-tiered supply chain, the number of BOMs involved in the supply chain may become so large that the brand-owner may no longer be able to maintain his own BOM without collaboration from other companies in the supply chain.

Further, a BOM is not static and may go through many changes over the course of its life. For example, the BOM itself can change as a result of adjustments made during the product's design, planning and manufacturing phases. Moreover, the location, sourcing, availability and criticality of a BOM component are not constants and can vary over time. For example, due to shortages or other changes in the marketplace, the suppliers may experience difficulties in getting raw materials or the suppliers may face “stock outs” due to sudden increases in demand. Whenever such changes occur, the BOM must be adjusted accordingly to accommodate the changes. Further, trading partners and suppliers are often located in foreign countries or regions where time zones are different from that of the brand owner, making it much more complex and difficult to communicate with them and effectively manage a BOM.

Managing the multifarious process of assembling a BOM becomes especially difficult when the products to be built based on the BOM have relatively short development and production cycles. In many industries, but particularly in certain vertical markets (e.g., consumer electronics, high tech and automotive markets), a product BOM will typically contain hundreds, even thousands of components and multi-component sub-assemblies that come from suppliers operating across many tiers.

The brand-owner is the main driving entity of the overall BOM assembly and the associated supply chain and the demand chain. The brand-owner communicates the BOM to its suppliers, keeps them informed of changes to it, and coordinates the efforts to assemble the materials described in the BOM. The brand-owner also conducts its communications over a multi-tiered supplier network of trading partners. The relationship between the brand-owner and the partners requires collaboration at a sophisticated level. The brand owner also performs marketing and sales over the various channels in the demand chain.

Conventional methods of managing a BOM often focus solely on the brand-owner's BOM, and fail to consider other BOMs that are maintained by the suppliers associated with the brand owner's multi-tiered supply chain. For example, MRP (Materials Resource Planning System) provides a mechanism to manage manufacturing database for parts, quantity, and suppliers. However, MRP is a centralized system that does not allow interaction between the brand owner and other suppliers detached from the direct chain of supply. Any changes at the suppliers' end must be communicated to the brand owner and manually entered into the brand owner's BOM. This is a very time-consuming and inefficient process.

Further, conventional methods of managing a BOM fail to provide an automated collaboration process for BOMs. For example, when there is a change in demand or supply, conventional methods such as MRP fail to provide any intelligent decision making assistance to the users. Any action or response to the change in production or demand must be determined by the user. The user then enters the user's response to the system or adjusts its database to reflect the change.

In view of the foregoing, it would be desirable to provide a distributed system where the brand owner and other suppliers and distributors involved in the production could interact with each other using a common database. It would be also desirable to provide an automated mechanism that provides an intelligent decision making assistance based on exceptions and out-of-tolerance events.

### SUMMARY OF THE INVENTION

The present invention provides a system and method to automate the collaboration process on a BOM that is distributed over the supply chain network and the demand chain network. The invention provides a mechanism for real time collaboration and management of exceptions. The invention also allows the distributed entities to collaboratively manage the BOM by providing inputs and making appropriate changes in response to variable supplies and demands. The invention provides a vehicle for the collaborative resolution of problems using web-based tools and messaging.

In one aspect, the invention provides a rules engine, an optimization engine, an applications server and a database server. The rules engine implements rule-based decision making functions. The rules engine provides flexibility to the system because the rules may be modified or updated as necessary in order to allow for production system modifications and changes. The optimization engine allows the system to simulate and resolve routine problems that may reoccur on a regular basis and provide a preferred, well-tested and unambiguous resolution to the routine problems.

In operation, the invention monitors for an arrival of an input entered by a business party or an event generated in the distributed production system. The invention may be programmed to track various parameters in connection with the distributed system. When an input is received, the invention makes an intelligent decision by determining whether the input represents an out-of-tolerance case. The rules engine applies applicable criteria to determine out-of-tolerance cases. If the input represents an out-of-tolerance case, the invention notifies a user or other business parties across the distributed system of difficulties and delays in production. If the input does not represent an out-of-tolerance case, the optimization engine crafts a corrective action in response to the input.

The invention enables the brand-owner to proactively respond to information entered by the brand owner's and multi-tier suppliers' PDMs, ERPs, SCMs, WMs and other systems in a distributed system. The invention stores the information in a common database, formats it and analyzes it. The invention may also model it visually or otherwise for the users to understand the situation in a glance. Thus, when an element becomes critical, a user can quickly see a visualized representation of the problem, enabling the user to determine the nature of the problem and respond properly.

### BRIEF DESCRIPTION OF THE DRAWINGS

FIG. 1 is a diagram illustrating a typical distributed production system involving a brand-owner, a supply chain network, and a demand chain network;

FIG. 2 illustrates the architecture of a CBOM constructed in accordance with one embodiment of the invention;

FIG. 3 is a flowchart illustrating the process of the rules engine 201. of FIG. 2; and

FIG. 4 illustrates architecture of a typical computer system implementing the CBOM of the invention;

FIG. 5 is a flowchart illustrating the basic functions performed by the CBOM in accordance with one embodiment of the invention;

FIG. 6 is a diagram illustrating an example of a input processing by a computer system implementing a CBOM of the invention; and

FIG. 7 is an exemplary flowchart illustrating the interaction between the manageDA 605 and the CBOM 601 in greater detail in accordance with one embodiment of the invention.

### DETAILED DESCRIPTION OF A PREFERRED EMBODIMENT

The present invention provides a mechanism to manage and automate the collaboration process for a bill of materials (BOM) on a distributed system comprising a supply chain network and a demand chain network. The invention provides a mechanism for real time collaboration and intelligent management of out-of-tolerance situations. The invention is particularly applicable to production systems involving a manufacturer (or brand-owner) for assembling and maintaining a bill of materials in collaboration with other supply and distribution entities. It will be appreciated, however, that the collaborative management mechanisms in accordance with the invention have greater utility, and are applicable to other types of applications on the Internet such as for general resource management and distributed system management. To understand the collaborative management mechanisms in accordance with the invention, the basic architecture of the collaborative management mechanisms will be described. Then, the application of the collaborative management mechanisms will be described in conjunction with distributed systems.

Overview—CBOM

The CBOM (collaboration bill of materials) of the invention provides a mechanism for real-time monitoring and proactive management for a highly complex BOM that involves components, sub-components and assemblies. The CBOM is preferably a software engine, i.e., a programmed computer system, that enables a manufacturing company or a brand owner to reach beyond the confines of its own organization to manage a portion of its supply chain specifically, those commercial activities that relate to the assembly of a bill of materials (BOM).

A typical modern brand-owner or manufacturer maintains and manages a supply chain network and a demand chain network. The supply chain network is a network of suppliers and sub-suppliers that supply components and sub-components to the brand-owner and other suppliers. The demand chain network is a network of distributors that receive goods from the brand-owner and distribute them to the end users or to other distributors. Further, the supply chain network and demand chain network associated with a brand-owner are typically global and distributed in various parts of the world. Thus, an effective monitoring and management of the production of the goods cannot be achieved without using one or more BOMs.

TABLE 1 illustrates a typical production chain network for a BOM of a product brand-owner such as a shoe manufacturer. Typically, a production BOM is developed for a manufacturer based on a design specification containing product specifications.

TABLE 1

| PART | QUANTITY | SUPPLIER |
|---|---|---|
| Top | 100,000 | Taiwan2 (Taiwan) |
| Sole | 150,000 | India3 (India) |
| Cushion | 150,000 | LA1 (Los Angeles) |
| String | 200,000 | Mexico1 (Mexico) |
| Logo | 100,000 | Canada4 (Canada) |

Thus if, for example, the shoe brand-owner is located in, for example, Dallas, Tex., the brand-owner must be able to monitor and respond to the events that occur in remotely located suppliers in order to make timely adjustments and effectively carry out its production and distribution plans.

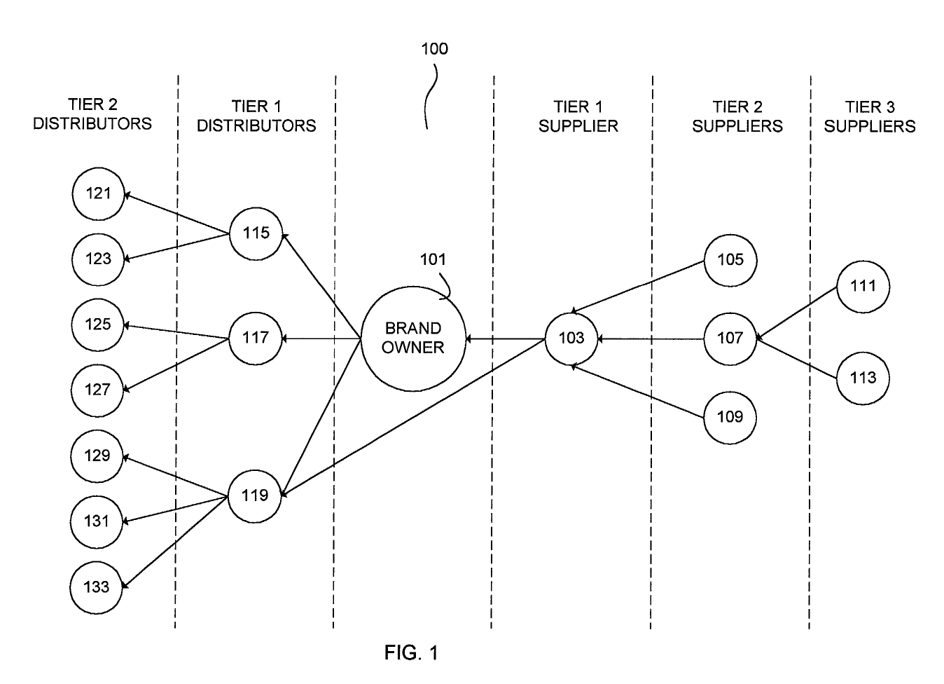

FIG. 1 is a diagram illustrating a typical distributed production system involving a brand-owner, a supply chain network, and a demand chain network. In FIG. 1, the brand owner 101 is the main driving entity of the network that produces a product. The product has an associated BOM. The BOM may be distributed over a supplier network of trading partners and the suppliers are classified by tiers into teir1, tier2, tier3, and so on, as illustrated in FIG. 1. The brand-owner 101 may be an actual manufacturer or act in a supervising capacity merely overseeing the assembly process of third parties without any manufacturing facility of its own.

Specifically, in the example of FIG. 1, the brand-owner 101 has a supply chain network comprising a tier 1 supplier 103, tier 2 suppliers 105, 107, and 109, and tier 3 suppliers 111 and 113. The demand chain network comprises tier 1 distributors 115, 117, and 119, and tier 2 distributors 121-133. As illustrated in FIG. 1, the suppliers (tier 1 suppliers) to the brand-owner may have their own sub-suppliers, i.e., tier 2 suppliers, that supply sub-parts or sub-assemblies to them. The tier 2 suppliers in turn may have tier 3 suppliers that supply to them. There may be other tiers of suppliers in the supply chain network.

Similarly, on the demand chain network are tiers of distributors that lead to the end consumers of the good being produced. In FIG. 1, there are tier 1, tier 2, and other tiers of distributors in the demand chain network. The direct line in FIG. 1 from the tier 1 supplier 103 to the tier1 distributor 119 illustrates a contract manufacturing/drop ship relationship.

Such multi-tiered production systems as illustrated in FIG. 1 make it prohibitively difficult for a brand-owner to keep track of the relationships between the suppliers and distributors, and to monitor all the changes that occur down the stream and up the stream. As will be described, the CBOM of the invention not only allows the brand-owner to monitor and respond to the tier 1 suppliers and distributors, but also allows to monitor and respond quickly to other tier suppliers and distributors.

The potential source of changes in a multi-tiered production system includes locations, sourcing, availability and criticality of various parts involved in a CBOM. There are various ways to monitor such production variables associated with a product. For example, product data management systems (PDMs), enterprise resource planning systems (ERPs), supply chain management systems (SCMs), demand chain management systems (DCMs), customer relationship management systems (CRMs), enterprise resource planning systems (ERPs), warehouse management systems (WMs), supplier relation management systems (SRMs), etc. may be used in conjunction with the invention in order to monitor variables and enter them into the system as inputs. Similarly, the demand variables such as forecast and availability of the widgets may be tracked using ERPs, demand chain management systems, channel management systems and marketplaces. The time variable can be tracked by specific time values or by time intervals.

In operation, the CBOM of the invention monitors the supply chain network and the demand chain network in an attempt to detect exceptions such as bottlenecks before they become critical problems. The CBOM of the invention also enables the brand-owner to proactively gather relevant information from the brand owner's and multi-tier suppliers' PDMs, ERPs, SCMs, WMs and other systems. The CBOM stores the information in a common database, formats and analyzes it. The CBOM database may be represented by using various methods such as XML (extensible markup language), electronic and non-electronic document formats. Access to the CBOM database may be controlled via any suitable access control protocol among various business parties in the distributed system.

CBOM Architecture

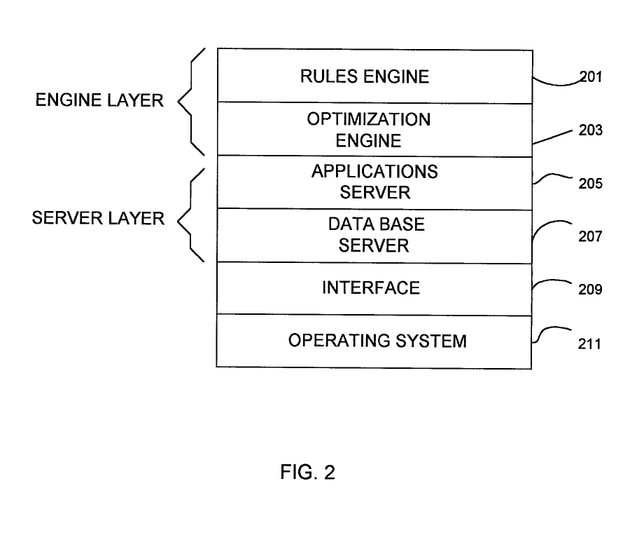

FIG. 2 illustrate the architecture of a CBOM constructed in accordance with one embodiment of the invention. The CBOM system may be composed of two specific layers: a server layer and an engine layer. The server layer may comprise an application server layer 205 and a database server layer 207, as illustrated in FIG. 2. The application server 205 is used to execute and perform application programs. The database server 207 is used to index, store and retrieve data.

In the engine layer, there are a number of special purpose programs such as a rules engine 201 and an optimization engine 203. The rules engine 201 implements rule-based decision making functions. The rules engine 201 provides flexibility to the system because the rules may be modified or updated as necessary in order to allow for production system modifications and changes. The optimization engine 203 is used to generate optimized solutions for non-critical problems. For example, the optimization engine 203 of the CBOM may allow the distributed system to resolve routine problems that may reoccur on a regular basis and provide preferred, well-tested and unambiguous resolutions to the routine problems. Thus the optimization engine 203 of the CBOM may implement a routine for determining whether the problem is a routine one, and provide well-tested resolutions to the problem. It will be appreciated that other architecture may be used to implement the CBOM in accordance with the invention and that layers may be added or removed as appropriate. For example, a web server layer may be added to the server layer of FIG. 2, or the optimization engine 203 may be removed from the architecture if no optimization is desired.

Preferably, the rules engine 201, the optimization engine 203, the application server 205, and the database server 207 are implemented using software codes. However, it will apparent to one skilled in the art that they may also be implemented using hardware circuitry.

The interface 209 acts as an interface to a variety of other, external systems. For example, the CBOM may interface and interact with external software programs, including but not limited to, ERP (enterprise resource planning), SCM (supply chain management), CRM (customer relationship management), and PDM (product data management). The interactions may involve sending and receiving data via events, messages or transactions. ERP systems typically store master data regarding manufacturing plans, human resources and accounting. The current transactional data may be read and modified by the CBOM. The historical data (in a data warehouse) may be read by the CBOM. The CBOM may monitor the events occurring in an ERP through the use of a software agent. An agent preferably refers to a computer program that may accept tasks from a human user, and determine actions to perform without human supervision. An agent may perform individually or work together with other software programs.

SCM systems store master data on planning, which includes demand plans and supply plans. The CBOM may read this data to access the current and future plans. It may post changes computed as a result of processing supply chain events. CRM systems hold information relevant to customers, such as users, orders and cases. The CBOM can read this data from a CRM and can also monitor events via an agent. Actions taken by the CBOM in response to supply chain events may result in changes to the cases in a CRM. PDM systems hold master data on product design. This is typically the source of a traditional BOM. The design specification is read from a PDM into a CBOM.

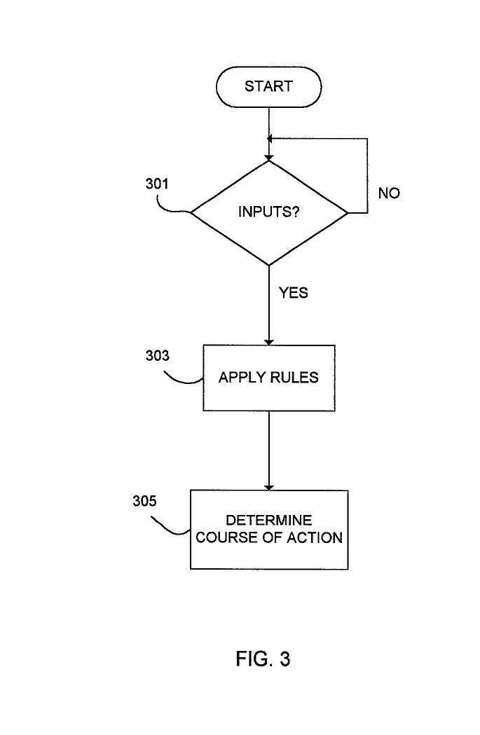

FIG. 3 is a flowchart illustrating the process of the rules engine 201. In FIG. 3, the rules engine 201 awaits an input in step 301. When an input is received, the rules engine 201 applies a predetermined set of rules to process the input. For example, if the input represents a 30% reduction in production of an item, the rules applied may be criteria for determining whether that represents an exception, i.e., an out-of-tolerance situation. In step 305, the rules engine 201 determines possible course(s) of action in response to the input. For example, if the input does not represent an out-of-tolerance problem, a possible course of action may be to take a corrective action. However, if the input represents an out-of-tolerance problem, a possible course of action may be reporting the problem to the user for further actions by the user.

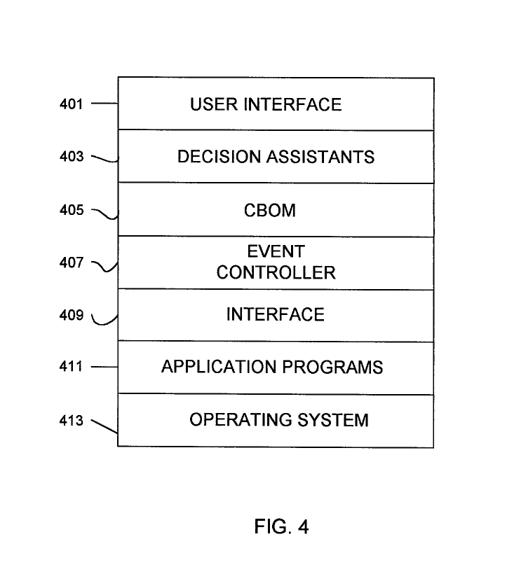

FIG. 4 illustrates the architecture of a typical computer system implementing the CBOM of the invention. In FIG. 4, the computer system comprises a user interface 401, decision assistants (DAs) 403, the CBOM 405, an event controller 407, an interface 409, application programs 411, and an operating system 419. The user interface 401 may comprise a graphical user interface. In operation, when a change is detected by an MRP program, the MRP program forwards the change to the event controller via the interface. Alternately, the CBOM 405 may actively monitor the MRP for changes and forward them to the event controller.

The decision assistants 403 may comprise one or more decision assistants (DA), each of which performs a different task. For example, the decision assistants 403 may comprise a manage decision assistant (manageDA), a buyer decision assistant (buyerDA), a seller decision assistant (sellerDA), a planner decision assistant (plannerDA), and a finance decision assistant (financeDA). The various decision assistants implement necessary functions using the underlying CBOM engines such as the rules engine and the optimization engine. Preferably, the manageDA acts as the general conduit for external events and also as a container for events not handled by other DAs. It also provides a container for general administrative tasks not handled by other DAs. The sellerDA application manages events occurring in the sales pipe line. The buyerDA application manages events related to procurement of material. The plannerDA application manages events related to production planning. And the financeDA application handles all events that requires a financial decision making. It will be appreciated by one skilled in the art that various other DAs may be added or removed from the layer 403 as appropriate. For example, the DAs may comprise coordinateDA to coordinate activities among other DAs.

The event controller 407 directs the inputs to the CBOM 405 or to the decision assistants 403. If the events are sent first to the CBOM 405, the CBOM 405 then activates an appropriate DA in 403, and sends the event to that DA. The interface 411 is used to accept inputs from the application programs 411 and route them to the event controller 409. The application programs 411 may comprise any suitable application program that may be used in conjunction with the invention. For example, ERP (enterprise resource planning) programs such as BW, APO, and R/3 software provided by SAP™ AG of Germany may be used as an application program.

In operation, the CBOM of the invention receives inputs from the various entities in the distributed system 100 involved in compiling the BOM. It also receives inputs from suppliers systems at any tier in the supply chain network. The CBOM uses these inputs to perform the following functions: (1) monitoring of the inputs, (2) measuring of the inputs, (3) the simulation of specific actions in order to identify and resolve exceptions, (4) notification of exceptions and (5) the control of routine processes.

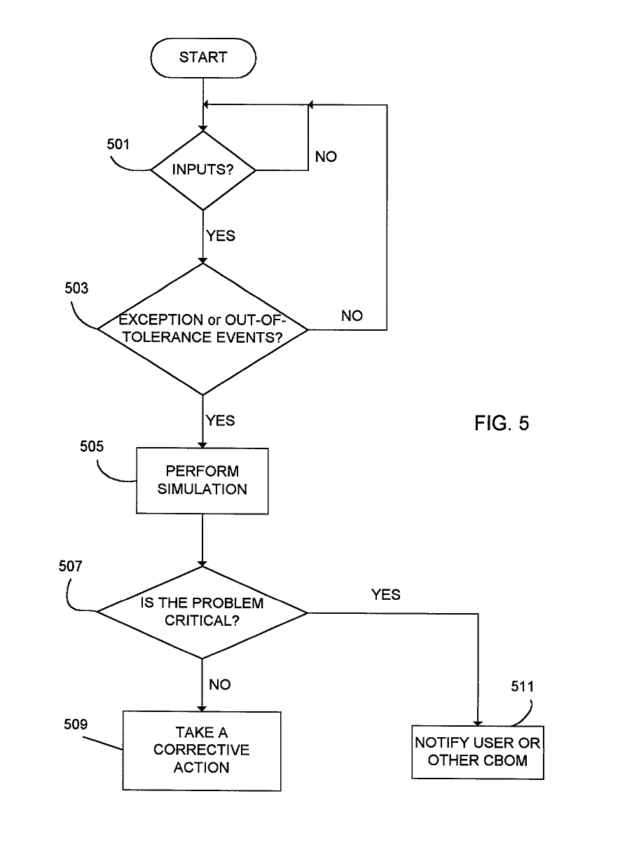

FIG. 5 is a flowchart illustrating the basic functions performed by the CBOM in accordance with one embodiment of the invention. Referring to FIG. 5, in step 501, the CBOM monitors the multi-tiered network to which it connects for inputs. The kinds of inputs it monitors can be programmed into the CBOM in order to track select events in the marketplace. The CBOM then converts an input to quantifiable data or some other measurable data. For example, information about CBOM components or subassemblies may be expressed as a quantity, or a date. The CBOM then captures quantifiable data and stores it.

In step 503, the CBOM determines whether the input received represents an exception or out of tolerance situation. It may be considered as an exception or out of tolerance situation when the supply or demand for a part or component rises above or falls below certain pre-determined criteria. For example, it may be programmed into the rules engine 201 that any change greater than 5% in production of an item represents an out-of-tolerance event. If there is an exception or out of tolerance situation, the CBOM of the invention, in step 503, performs a simulation in order to assess the impact of a supply chain problem by interpreting its down-stream impact. The CBOM of the invention is flexible because other parameters or rules may be programmed into the rules engine 201 in order to implement step 503 as appropriate.

In step 507, the CBOM determines whether the problem is critical. A problem is considered critical when the out-of-tolerance problem cannot be corrected by some corrective measures. For example, if there is 5% reduction in the supply of an item, that would represent an out-of-tolerance event. However, if there is 10% safety stock for that item, the 5% shortage would not be a problem because it can be replenished from the safety stock. If, however, there is no safety stock or other source to make up for the shortage, the out-of-tolerance event becomes critical. If a component being tracked by the CBOM becomes critical, the CBOM, in step 511, recognizes the problem and notifies responsible users when there are unanticipated events that will affect the timely construction of a product. The CBOM may respond by providing a notification of difficulties and delays in procuring components and sub-assemblies across all supplier tiers.

The CBOM may also model the situation visually or otherwise for the user(s) in charge of CBOM development. For example, it may present the problem to the user(s) visually, showing the user(s) where the problem exists. The user can click on the screen to learn more about the problem and where it exists. Visual representation allows, for example, a SCM professional to merely look at a screen to get a visual and electronic representation of a BOM and the collaborations that are involved in the production. Because a BOM often involves components that come from various parts of the world, the ability to glance at a screen and understand how a BOM is assembled and identify places where delays or process breakdowns might impact upstream elements of the process, provides a significant advantage to the users.

Optionally, the CBOM of the invention may provide means to analyze the problem and generate alternative plans for the users. For example, if the nominal production plan is at risk of failing to meet the expected date or quantity due to an exception situation, the CBOM may produce alternate plans and present them to the user so that the user can evaluate alternate plans to mitigate or avoid the risk. For example, if the CBOM recognizes the problem as being of a general nature, the CBOM may apply analysis and rules-based reasoning to respond to them. Thus, if there is a shortage of material at some point in the supply chain, the shortage situation may be avoided by selecting an alternative plan generated by the CBOM which offers an alternate source for the material.

Further, after recognizing an exception and analyzing it, the CBOM of the invention may visually present, e.g., display, the anticipated outcomes of each alternative plan to the user. For example, when a brand owner's nominal production plan may be at risk due to an exception in the form of a material shortage, an SCM professional could benefit by using the CBOM in order to receive a list of alternative sources for the material. The CBOM may be programmed to provide detailed analysis data such as advantages and disadvantages associated with different sources that would help the SCM professional to visually assess the pros and cons associated with the selection of each alternate source. Such advantages and disadvantages may include information regarding unit cost, cost break-points, volume discounts, and delivery options. Being able to see the financial and time-related implications associated with each option would help the SCM professional to choose the best path to resolve the exception. It also provides a vehicle for the collaborative resolution of problems using web-based tools and messaging. Further, it enables decision agents to resolve routine problems that may occur over and over again and which have a preferred, well-tested and unambiguous resolution.

Still referring to FIG. 5, if the problem is not critical in step 507, an optimization engine of CBOM may take a simple, corrective action in step 509. For the above example, a corrective action may be to issue an instruction or suggestion to use reserve items from the safety stock to make up for the 5% reduction. The corrective step 509 is optional and may be skipped.

In one application, the CBOM of the invention may comprise a computer program that resides only at the brand-owner's computer. In this case, other business entities including suppliers and distributors may use any appropriate system to manage their own production and business plans. If there is a change in the production plan of a supplier, the supplier can communicate the change to the brand-owner so that the change can be entered into and processed by the CBOM of the brand-owner. The communication between the brand-owner and the business entities may be performed using any well-known methods such as EDI (electronic data interchange), web browser, or even conventional telephones.

In another application, a plurality of business entities in the distributed system may implement a distributed system using the CBOM of the invention. In this case, a supplier may execute its own CBOM algorithms to receive and process problems. If the problems cannot be processed on its own, the supplier may communicate the problems to other CBOMs in the system. For example, if the problem is critical and requires a change in the production plan, it notifies other CBOMs. If the problem is critical and of nature that cannot be resolved by other suppliers, the CBOM who detected the problem may make a decision to communicate the problem to the brand-owner's CBOM so that more global solution can be fashioned by the brand-owner's CBOM. The communication between the CBOMs may be performed using any well-known methods such as EDI (electronic data interchange), web browser, or even conventional telephones.

When there are multiple instances of CBOM in the distributed system, a collaboration is enabled among the CBOMs. In order to achieve a collaboration among suppliers and distributors in the distributed system, the notification in step 511 may notify the user(s) or to other CBOMs. A collaboration starts when the notification is made to other CBOMs. For example, when the CBOM managed by the supplier 103 of FIG. I detects a demand to increase the production of a sub-part, it may first notify the CBOM of the supplier 105, provided the supplier 105 has its own CBOM. The supplier 105 CBOM may perform its own processing routines illustrated in FIG. 5. If the supplier 105 cannot properly respond to the demand, the supplier 105 CBOM may then notify the CBOM of the brand-owner 101, who may retain the ultimate control over the overall production and demand plan. The brand-owner CBOM 101 may then perform the processing routines shown in FIG. 5 in order to resolve the situation.

Thus, the CBOM of the invention provides an automated production management system, enabling collaboration and eliminating the need for a conventional, centralized BOM management system. As a result, the CBOM of the invention requires fewer people to manage a complex BOM compared to conventional methods. In accordance with the invention, if key business partners such as suppliers or distributors at any tier begin to miss production deadlines or otherwise fail to supply BOM components or sub-assemblies, the invention will readily detect these and take corrective actions before the impact ripples all the way to the customer's end of the supply chain and possibly causes irreparable damage to the production plan.

Further, the CBOM of the invention enables intelligent decisions. For example, when a supply delay is routine, e.g., there is a history of delay by the particular supplier and there is a well defined alternative to resolve it, the CBOM may take automatic action to correct a problem proactively without requiring user interventions.

CBOM Application Example

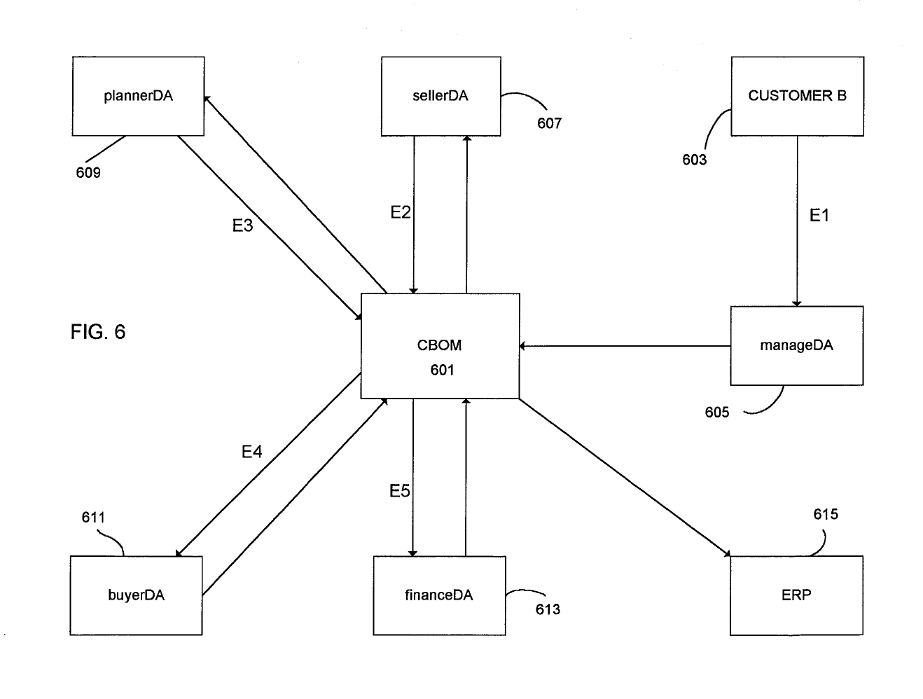

FIG. 6 is a diagram illustrating an example of a input processing by a computer system implementing a CBOM of the invention. The computer system shown in FIG. 6 comprises a CBOM 601, a manageDA 605, a plannerDA 609, a sellerDA 607, a buyerDA 611, a financeDA 613, and an ERP 615. In the application example shown in FIG. 6, the CBOM serves as a collaboration engine through which information, in the form of events, is exchanged. In addition to managing the BOM-related event information that is exchanged between members of the distributed system, the CBOM may also accept and process information from external systems such as ERP 615.

Referring to FIG. 6, a company A uses the CBOM, to manage its supply chain execution management. The company A may sell its products through various retail outlets. One of A's major customers is B, a national retailer. B has a network connection to A's CBOM system. B passes order information to A over that connection.

For the last few years A has manufactured a product P. The product is sold in B stores as well as in other retail stores. The product has sub-assemblies that include a video camera, a printed circuit board, a power supply and a box. In the spring quarter, B notices a surge in sales of P. In response, B increases its firm summer-quarter order for the product by 200%.

Referring to FIG. 6, the actual change order from customer B 603 is communicated as an event E1 to the CBOM 601 via manageDA 605 as illustrated in FIG. 6. The CBOM 601 accepts E1, measures it and determines that there is an unanticipated 200% increase in the number of P products ordered. The CBOM 601 notifies sellerDA 607.

Next, the seller DA 607 processes E1 using the CBOM engine. The seller DA 607 recognizes and accepts an increase in demand for the product P. By doing so the sellerDA 607 triggers another event E2. Event E2 triggers replanning in plannerDA 609 by generating a new event E3. Event E3 causes plannerDA 609 to initiate an increase in production. The increase in production requires an increased procurement of, for example, video cameras. The CBOM 601 posts an event E4 to procure more video cameras in the buyerDA 611.

If the primary supplier of video cameras cannot fulfill this increase in demand for some reason, the buyerDA 611 recognizes the situation. The buyerDA 611 may decide to procure the additional video cameras from an alternate supplier at a higher cost. Because a higher cost is required, the buyerDA 611 triggers an additional event E5, which is generated by the CBOM 601 and posted to the financeDA 613. The financeDA 613 processes the event E5 that notifies the increase in production cost for the lot and hence, a change in the margin. The financeDA 613 communicates the cost increase and margin change back to the CBOM 601, which in turn communicates the cost and margin information to the ERP 615.

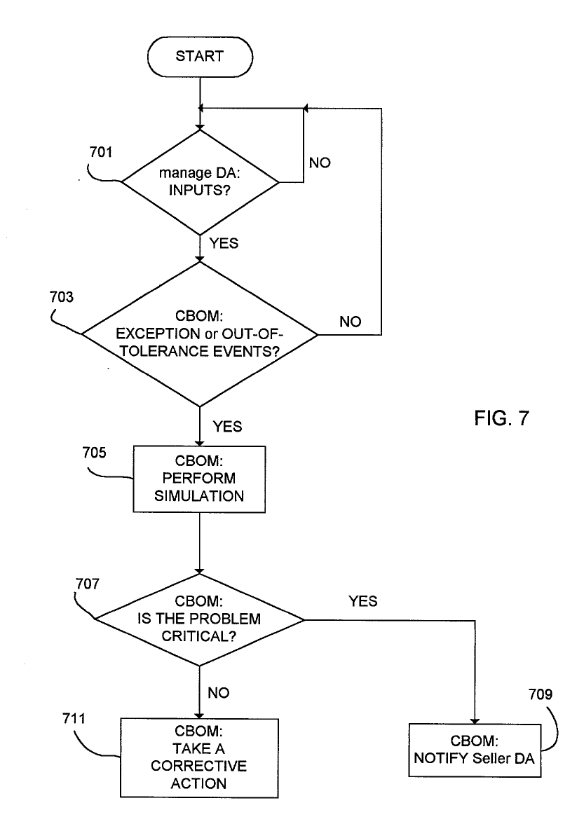

FIG. 7 is an exemplary flowchart illustrating the interaction between the manageDA 605 and the CBOM 601 in greater detail in accordance with one embodiment of the invention. Other DAs—buyerDA, sellerDA, and financeDA—may also implement similar routines.

Referring to FIG. 7, in step 701, the manageDA 605 monitors for inputs that come from across the multi-tiered network to which it connects. The manageDA routes the received input to the CBOM 601, which then converts the input to quantifiable data or some other measurable data. The CBOM 601 then captures quantifiable data and stores it.

In step 703, the CBOM 601 determines whether the input received represents an exception or out of tolerance situation by applying a set of predetermined rules, as described above in reference to FIG. 5. If there is an exception or out of tolerance situation, the CBOM 601, in step 705, performs a simulation in order to assess the impact of a supply chain event by interpreting its down-stream impact.

In step 707, the CBOM 601 determines whether the problem is critical, as described above in reference to FIG. 5. If the problem is critical, the CBOM, in step 709, recognizes the problem and notifies the sellerDA 607. The CBOM 601 may also notify the user(s) or other CBOMs. Optionally, the CBOM 601 may provide means to analyze the problem and generate alternative plans for the users. If the problem is not critical in step 707, an optimization engine of the CBOM 601 may take a simple, corrective action in step 711.

The foregoing descriptions of specific embodiments of the present invention are presented for purposes of illustration description. They are not intended to be exhaustive or to limit the invention to the precise forms disclosed. The above discussion, examples and embodiments illustrate our current understanding of the invention. However, it will be appreciated by those skilled in the art that many variations of the invention can be made without departing from the spirit and scope of the invention, the scope of which is defined by the appended claims.

1. A method for managing a bill of material (BOM) for a product comprising parts contributed by a plurality of parties in a distributed system comprising a brand-owner, at least one first-tier supplier and at least one first-tier distributor, wherein said BOM contains information regarding said parts and suppliers of said parts; the method comprising:
monitoring the distributed system for an arrival of an input entered by a first party in said distributed system,
automatically determining whether said input represents an out-of-tolerance case,
communicating said input to a second party when said input represents said out-of-tolerance case;
determining whether an alternative plan is available when said input represents said out-of-tolerance case; and
optimizing a resolution in response to said input when said input does not represent said out-of-tolerance case,
whereby an automated collaboration between said first and second parties is enabled so that when said first party is unable to respond to said input, said input is communicated to said second party in order to allow said second party to process said input.

2. The method of claim 1 wherein said determining whether said input represents an out-of-tolerance case comprises applying a set of predetermined rules to said input.

3. The method of claim 2 further comprising performing a simulation for an impact of said input when said input represents said out-of-tolerance case.

4. The method of claim 3 further comprising communicating said alternative plan to said user.

5. The method of claim 4 wherein said determining at least one alternative plan comprises finding an alternative source for one of said parts.

6. The method of claim 5 wherein said distributed system comprises a second tier supplier and said input originates from said second tier supplier.

7. The method of claim 1 wherein said optimizing comprises issuing an instruction to increase a production of a part provided by said first-tier supplier when said input comprises an increase in a demand for said product.

8. The method of claim 7 wherein said optimizing comprises assessing an impact of said instruction to increase said production on a cost of said product.

9. The method of claim 1 wherein said optimizing comprises issuing an instruction to decrease a production of a part of said product when said input comprises a decrease in a demand for said product.

10. The method of claim 1 wherein said optimizing comprises issuing an instruction to decrease a production of a part of said product when said input comprises a decrease in a supply by said first-tier supplier.

11. A computer program product for use in conjunction with a bill of material (BOM) for a product comprising parts contributed by a plurality of parties in a distributed system comprising a brand-owner, at least one first-tier supplier and at least one first-tier distributor, wherein said BOM contains information regarding said parts and suppliers of said parts; the computer program product comprising a computer readable storage medium and a computer program mechanism embedded therein, the computer program mechanism comprising:
instructions for monitoring for an arrival of an input entered by a first party in said distributed system;
instructions for determining whether said input represents an out-of-tolerance case;
instructions for communicating said input to a second party when said input represents said out-of-tolerance case;
instructions for determining whether an alternative plan is available when said input represents said out-of-tolerance case; and
instructions for optimizing a resolution in response to said input when said input does not represent said out-of-tolerance case.

12. The computer program product of claim 11 further comprising instructions for determining whether said input represents said out-of-tolerance case comprises instructions for applying a set of predetermined rules to said input.

13. The computer program product of claim 12 wherein said instructions for performing a simulation for an impact of said input when said input represents said out-of-tolerance case.

14. The computer program product of claim 13 further comprising instructions for communicating said alternative plan to said user.

15. The computer program product of claim 14 wherein said instructions for said determining at least one alternative plan comprises instructions for finding an alternative source for one of said parts.

16. The computer program product of claim 15 wherein said distributed system comprises a second tier supplier and said input originates from said second tier supplier.

17. The computer program product of claim 11 wherein said optimizing comprises issuing an instruction for increasing a production of a part provided by said first-tier supplier when said input comprises an increase in a demand for said product.

18. The computer program product of claim 17 wherein optimizing comprises assessing an impact of said instruction for increasing said production on a cost of said product.

19. The computer program product of claim 11 wherein said optimizing comprises issuing an instruction to decrease a production of a part of said product when said input comprises a decrease in a demand for said product.

20. The computer program product of claim 11 wherein said optimizing comprises issuing an instruction to decrease a production of a part of said product when said input comprises a decrease in a supply by said first-tier supplier.

21. A method for managing a bill of material (BOM) for a product comprising parts contributed by a plurality of parties in a distributed system comprising a brand-owner, at least one first-tier supplier, one second-tier supplier, and one first-tier distributor, wherein said BOM contains information regarding said parts and suppliers of said parts; the method comprising:
monitoring the distributed system for an input entered by a first party in said distributed system;
automatically determining whether said input represents an out-of-tolerance case;
optimizing a resolution in response to said input when said input does not represent an out-of-tolerance case, and
communicating said input to a second party in said distributed system when said input represents an out-of-tolerance case;
whereby an automated collaboration between said first and second parties is enabled so that when said first party is unable to respond to said input, said input is communicated to said second party to allow said second party to process said input.

22. The method of claim 21 further comprising notifying a user when said input represents an out-of-tolerance case.

23. The method of claim 21 wherein said first party comprises a first tier supplier in said distributed system.

24. The method of claim 23 wherein said second party comprises a second tier supplier in said distributed system.

25. The method of claim 23 wherein said second party comprises said brand-owner.

26. The method of claim 21 further comprising determining at least one alternative plan when said input represents an out-of-tolerance case.

27. The method of claim 26 further comprising communicating said alternative plan to a user.

28. The method of claim 21 wherein said determining whether said input represents an out-of-tolerance case comprises applying a set of rules to said input.

29. The method of claim 28 further comprising simulating an impact of said input on said distributed system.

30. The method of claim 29 wherein said determining at least one alternative plan comprises finding an alternative source for one of said parts.

31. The method of claim 21 wherein said optimizing comprises changing a design specification of said product.

32. The method of claim 21 wherein said optimizing comprises obtaining a subset of said parts from an alternative source.

33. The method of claim 32 wherein said alternative source comprises a safety stock.

34. The method of claim 21 wherein said optimizing comprises issuing an instruction to increase a production of a part provided by said first-tier supplier when said input comprises an increase in a demand for said product.

35. The method of claim 34 wherein said optimizing comprises assessing an impact of said instruction to increase said production on a cost of said product.

36. The method of claim 21 wherein said optimizing comprises issuing an instruction to decrease a production of a part of said product when said input comprises a decrease in a demand for said product.

37. The method of claim 21 wherein said optimizing comprises issuing an instruction to decrease a production of a part of said product when said input comprises a decrease in a supply by said first-tier supplier.

38. A computer program product for use in conjunction with a bill of material (BOM) for a product comprising parts contributed by a plurality of parties in a distributed system comprising a brand-owner, at least one first-tier supplier, one second-tier supplier, and one first-tier distributor, wherein said BOM contains information regarding said parts and suppliers of said parts, the computer program product comprising a computer readable storage medium and a computer program mechanism embedded therein, the computer program mechanism comprising:
instructions for monitoring for an input entered by a first party in said distributed system;
instructions for determining whether said input represents an out-of-tolerance case;
instructions for communicating said input to a second party in said distributed system when said input represents an out-of-tolerance case; and
instructions for optimizing a resolution in response to said input when said input does not represent an out-of-tolerance case.

39. The computer program product of claim 38 further comprising instructions for notifying a user when said input represents an out-of-tolerance case.

40. The computer program product of claim 38 wherein said first party comprises a first tier supplier in said distributed system.

41. The computer program product of claim 40 wherein said second party comprises a second tier supplier in said distributed system.

42. The computer program product of claim 38 wherein said second party comprises said brand-owner.

43. The computer program product of claim 38 further comprising instructions for determining at least one alternative plan when said input represents an out-of-tolerance case.

44. The computer program product of claim 43 further comprising instructions for communicating said alternative plan to a user.

45. The computer program product of claim 38 wherein said instructions for determining whether said input represents an out-of-tolerance case comprises instructions for applying a set of rules to said input.

46. The computer program product of claim 45 further comprising instructions for simulating an impact of said input on said distributed system.

47. The computer program product of claim 46 wherein said instructions for determining at least one alternative plan comprises instructions for finding an alternative source for one of said parts.

48. The computer program product of claim 38 wherein said optimizing comprises changing a design specification of said product.

49. The computer program product of claim 38 wherein said optimizing comprises obtaining a subset of said parts from an alternative source.

50. The computer program product of claim 49 wherein said alternative source comprises a safety stock.

51. The computer program product of claim 38 wherein said optimizing comprises issuing an instruction for increasing a production of a part provided by said first-tier supplier when said input comprises an increase in a demand for said product.

52. The computer program product of claim 51 wherein said optimizing comprises assessing an impact of said instruction for increasing said production on a cost of said product.

53. The computer program product of claim 38 wherein said optimizing comprises issuing an instruction for decreasing a production of a part of said product when said input comprises a decrease in a demand for said product.

54. The computer program product of claim 38 wherein said optimizing comprises issuing an instruction for decreasing a production of a part of said product when said input comprises a decrease in a supply from said first-tier supplier.

55. The computer program product of claim 38 further comprising:
instructions for initiating a seller DA (decision assistant) when said input is related to a sale of said product; and
instructions for initiating a buyer DA when said input is related a procurement of said parts.

56. The computer program product of claim 55 further comprising:
instructions for initiating a planner DA when said input requires a change to a production plan of said product; and
instructions for initiating a finance DA when said input requires a financial decision making.

57. A computer system for a bill of material (BOM) for a product comprising parts contributed by a plurality of parties in a distributed system, the computer system comprising:
a rules engine comprising a set of rules applicable to an input;
an optimization engine comprising a database of alternative sources of said parts for determining an alternative plan in response to said input; and
a server layer comprising instructions for servicing application programs and maintaining a BOM database.

58. The computer system of claim 57 wherein said server layer comprises:
an applications server comprising said instructions for servicing application programs; and
a database server comprising said instructions for maintaining said BOM database.
